(19) United States
(12) Patent Application Publication
(10) Pub. No.: US 2003/0124367 A1
(43) Pub. Date: Jul. 3, 2003

(54) Antistatic polyester-polyethylene glycol compositions

(76) Inventors: Scott Ellery George, Kingsport, TN (US); Douglas Stephens McWilliams, Kingsport, TN (US); Rodney Scott Armentrout, Kingsport, TN (US)

Correspondence Address: Eastman Chemical Company, P.O. Box 511, Kingsport, TN, 37662-5075, US

(21) Appl. No.: 10/308,748

(22) Filed: Dec. 3, 2002

Related U.S. Application Data
(60) Provisional application No. 60/337,992, filed on Dec. 6, 2001.

(51) Int. Cl. B32B 27/06

(52) U.S. Cl. 428/480

(57) ABSTRACT

The polyester-polyethers of the present invention are block copolymers wherein the polyester component may be crystalline or amorphous, while the polyether component is comprised of a polyethylene glycol having a molecular weight from about 990 to 3600 g/mole. Optionally, salts of 5-sulfoisophthalic acid (5-SIPA) may be included in the polyester component for superior static dissipative performance. Low levels of 5-SIPA, 0.05-5 mole %, are surprisingly effective at enhancing static dissipative performance. One aspect of this invention relates to antistatic blends having very low ionic extractables.

### CROSS REFERENCE TO RELATED APPLICATION

This application claims the benefit, under 35 USC 119, of Provisional Application Serial No. 60/337,992, filed Dec. 6, 2001, incorporated herein by reference.

### FIELD OF THE INVENTION

This invention relates to polyester-polyether compositions that are static dissipative and may be blended with other polymers to impart static dissipative characteristics to various articles of manufacture, particularly films, sheet, molded articles, and fibers.

### BACKGROUND OF THE INVENTION

U.S. Pat. No. 2,393,863 describes the use of polyethylene glycol (PEG) as a film-forming antistatic agent which could be applied to substrates, such as glass or vinyl polymers.

U.S. Pat. No. 3,652,712 describes certain polyester-polyether compositions for antistatic fibers and films.

U.S. Pat. No. 3,560,591 describes certain polyester-polyether compositions containing organic sulfonic acid salts.

Japanese Patent J10088423 describes certain polyethylene terephthalate fibers that are rendered antistatic through the admixing of both PEG and an organic sulphonic acid metal salt.

U.S. Pat. No. 5,346,959, teaches that the combination of polyethers with inorganic salts results in a complex that is conductive in the solid state. The use of a low molecular weight salt that is water soluble will lead to high levels of ionic extractables.

### SUMMARY OF THE INVENTION

The polyester-polyethers of the present invention are block copolymers wherein the polyester component may be crystalline or amorphous, while the polyether is comprised of a polyethylene glycol having a number average molecular weight from about 990 to 3600 g/mole. Optionally, salts of 5-sulfoisophthalic acid (5-SIPA) may be included in the polyester component for superior static dissipative performance. Low levels of 5-SIPA, 0.05-5 mole %, are surprisingly effective at enhancing static dissipative performance. A preferred aspect of this invention relates to antistatic blends having very low ionic extractables.

### DETAILED DESCRIPTION OF THE INVENTION

The present invention provides a block copolymer composition comprising a polyester-polyether prepared from the reaction products of:

(i) a diacid which is other than a sulfomonomer;

(ii) optionally, 0.05 to 5 mole %, based on the total mole % of all carboxyl, ester, and hydroxyl equivalents, of at least one difunctional sulfomonomer containing at least one metal sulfonate group bonded to an aromatic ring wherein the functional groups are ester, carboxyl, or hydroxyl;

(iii) 5 to 50 mole %, based on the total mole % of hydroxyl equivalents, of at least one polyethylene glycol having the structure:

H—(OCH₂CH₂)ₙ—OH

where 22≦n≦80; and

(iv) from greater than 50 to less than 95 mole %, based on the total moles of hydroxyl equivalents of a glycol or mixture of glycols that is(are) other than a polyethylene glycol;

wherein the polymer is comprised substantially of equal molar proportions of acid equivalents (100 mole %) and glycol equivalents (100 mole %) and wherein the inherent viscosity is at least 0.1 dL/g as measured in a 60/40 parts by weight solution of phenol/tetrachloroethane at 25° C. at a concentration of about 0.25 g of polymer in 100 mL of the solvent.

We have discovered antistatic polyester-polyether compositions where the polyether component is comprised of polyethylene glycol in the 990 to 3600 g/mole (i.e., 22≦n≦80) number average molecular weight range; in a preferred embodiment, 30≦n≦60. Optionally, any of the polyester-polyether compositions described herein may contain low levels of copolymerized sulfonic acid salts to further enhance antistatic performance. Although the polymers disclosed exhibit various and advantageous degrees of hygroscopicity, they may or may not be water-dispersible and water-dispersibility is not a requirement for the practice of this invention.

Component (i) is a dicarboxylic acid that is not a sulfomonomer and may constitute up to 100 mole % of the total moles of acid. It is to be understood that the use of the corresponding acid anhydrides, esters, and acid chlorides is included in the term “dicarboxylic acid”. Examples of suitable diacids include aliphatic diacids, alicyclic dicarboxylic acids, aromatic dicarboxylic acids, or mixtures of two or more of these acids. Although not limiting, suitable dicarboxylic acids include succinic; glutaric; adipic; azelaic; sebacic; fumaric; maleic; itaconic; 1,3-cyclohexane dicarboxlic; 1,4-cyclohexanedicarboxylic; diglycolic; 2,5-norbornanedicarboxylic; phthalic; terephthalic; 1,4-naphthalenedicarboxylic; 2,5-naphthalenedicarboxylic; 2,6-naphthalenedicarboxylic; 2,7-naphthalenedicarboxylic; diphenic; 4,4′-oxydibenzoic; 4,4′-sulfonyldibenzoic; and isophthalic. Terephthalic acid and isophthalic acid are preferred diacids for use as component (i). Compared to acid chlorides and acid anhydrides, dimethyl esters are preferred and it is also acceptable to include higher order alkyl esters, such as ethyl, propyl, isopropyl, butyl, and so forth in the preparation of the polyester-polyethers. In addition, aromatic esters, particularly phenyl, may also be considered.

The optional component (ii) is a difunctional sulfomonomer that is advantageously selected from a dicarboxylic acid or ester thereof containing a metal sulfonate group (—SO₃M) or a diol containing a metal sulfonate group derived from the reaction product of a dicarboxylic acid or ester thereof with a diol. The cation of the sulfonate salt may be a metal ion, such as Li⁺, Na⁺, K⁺, Mg⁺⁺, Ca⁺⁺, Cu⁺⁺, Ni⁺⁺, Fe⁺⁺⁺, and the like. The monovalent cations, derived from the Group 1, alkali metals are preferred due to their solubility and melt processability. Also contemplated herein are non-metallic sulfonate salts, such as the nitrogenous bases described in U.S. Pat. No. 4,304,901, incorporated herein by reference. A nitrogen-based cation will be derived from nitrogenous bases, which may be aliphatic, cycloaliphatic, or aromatic compounds. Examples of suitable nitrogen-containing bases are ammonia, pyridine, morpholine, and piperidine. While the antistatic polyester-polyether compositions are melt processable with other polymers, it is also contemplated that the polyester-polyethers may be applied as coatings. Solutions or dispersions of any of the polyesters herein may be effected in organic solvent, water, or organic solvent/water mixtures. Those skilled in the art will recognize that the term “solution” is meant to include not only true homogeneous solutions, but also dispersions, emulsions and the like. It is preferred to minimize the amount of organic solvent in order to limit VOC emissions into the environment. Solutions of the polyesters are also highly amenable to ion-exchange procedures, which are useful to obtain a wide variety of counterions that are not soluble or stable in the polymer melt phase. Thus, one example of this particular embodiment is to prepare the polyester using a sodium sulfonate salt and then by ion-exchange methods replace the sodium with a different ion, such as a divalent (e.g., zinc), when the polyester is in solution. This type of ion-exchange procedure is generally superior to preparing the polyester with divalent or trivalent salts inasmuch as the monovalent salts (e.g., sodium) are more soluble in the polymer reactant melt phase. Another example of this embodiment is to employ ion-exchange procedures to obtain the nitrogenous counterions, since amine salts tend to be unstable at typical melt synthesis conditions. Advantageous difunctional sulfomonomers are those where the sulfonate group is attached directly to an aromatic nucleus, such as benzene, naphthalene, diphenyl, oxydiphenyl, sulfonyidiphenyl, or methylenediphenyl. Preferred results are obtained through the use of sulfophthalic acid, sulfoterephthalic acid, sulfoisophthalic acid and those esters as described in U.S. Pat. No. 3,779,993, incorporated herein by reference. Particularly superior results are achieved when the difunctional sulfomonomer is 5-sodiosulfoisophthalic acid or 5-lithiosulfoisophthalic acid and the corresponding esters thereof. It is preferred for the optional reactant (ii) to be present in an amount of 0.05 to 5 mole %, more preferably about 0.1 to 3 mole %, and most preferably 0.5 to 1 mole %, based on total equivalents of acid and hydroxyl equivalents. Surprisingly, higher levels of 5-sodiosulfoisophthalic acid do not result in improved conductivity and are most likely deleterious as they often contain relatively high levels of by-product salts. Cleanliness (i.e., low extractables) is important for some of the applications envisioned by the present invention and salts, which are comprised of ionic species, are particularly detrimental to certain applications, such as hard disk drive (HDD) packaging.

The polyethylene glycol (PEG), component (iii), is used to place hydrophilic, but non-ionic blocks within the polymer backbone. We have found that other polyalkylene glycols, such as polypropylene glycol, polybutylene glycol, and polytetramethylene ether glycol, do not have sufficient hydrophilicity and are not suitable for the practice of this invention.

Representative examples of useful polyethylene glycols of the formula:

HO—(CH₂CH₂—O)ₙ—H (22≦n≦80)

include the commercially available products known under the Carbowax® trademark, a product of The Dow Chemical Company. Based on the values of n, which range from 22 to 80, the molecular weight of (iii) may range from about 990 g/mole to 3600 g/mole. The preferred molecular weight range is from about 1000 to 3000 g/mole. Lower molecular weight PEG's, particularly diethylene (n=2), triethylene (n=3), and tetraethylene glycols (n=4) do not impart static dissipative characteristics to polyesters. Higher molecular weight PEG's, where n is greater than 80, do result in static dissipative polyesters, but are not as effective as the intermediate molecular weight polyethylene glycols and, therefore, are not suitable for this invention. Higher molecular weight PEG's also result in polyester-polyethers with poorer physical properties and are difficult to melt process. The amount of reactant (iii) is specified to be 5 to 50 mole %, based on total glycol, preferably 10 to 40 mole %, and more preferably 15 to 30 mole percent. Lower levels of PEG do not provide adequate static dissipative performance, while very high levels do not further increase static dissipative performance and generally result in waxy polyesters that are difficult to melt process.

The glycol component, (iv), includes aliphatic, alicyclic, and aralkyl glycols. Examples of these glycols include, but are not limited to ethylene glycol; propylene glycol; 1,3-propanediol; 2,2-dimethyl-1,3-propanediol; 2-ethyl-2-butyl-1,3-propanediol; 1,3-butanediol; 1,4-butanediol; 1,5-pentanediol; 1,6-hexanediol; 1,2-cyclohexanedimethanol; 1,3-cyclohexanedimethanol; 1,4-cyclohexanedimethanol; and p-xylylenediol. Due to facile reactivity, it is preferred to employ glycols containing two —CH₂OH groups. As described supra, diethylene glycol, triethylene glycol, tetraethylene glycol, and so forth may also be included in the polymer composition. It is important to recognize that certain glycols of (iv) may be formed in situ due to side reactions that may be controlled by varying the process conditions. The preferred example of this is the formation of varying proportions of diethylene, triethylene, and tetraethylene glycols from ethylene glycol or mixtures of ethylene glycol with said glycols due to an acid-catalyzed dehydration, which occurs readily when a buffer is not added to raise the pH of an acidic reaction mixture. In the context of the present invention these types of side-reactions are known to occur in the presence of the optional component (ii), which is a sulfomonomer.

To obtain the polymers of this invention, all of the components, including the optional difunctional sulfomonomer, can be added together at the start of the reaction from which the polymer is synthesized. Other processes are known and they may also be employed. Illustrative examples from the art include U.S. Pat. Nos. 3,018,272; 3,075,952; and 3,033,822, incorporated herein by reference. These patents disclose interchange reactions as well as polymerization processes. Briefly, a typical procedure consists of at least two distinct stages; the first stage, known as esterification or ester-interchange, is conducted under an inert atmosphere at a temperature of 150 to 250° C. for 0.5 to 8 hours, preferably from 180 to 230° C. for 1 to 4 hours. The glycols, depending on their reactivities and the specific experimental conditions employed, are normally used in molar excesses of 1.05 to 3 moles per total moles of acid-functional monomers. The second stage, referred to as polycondensation, is conducted under a reduced pressure at a temperature of 200 to 350° C., preferably 220 to 300° C., and more preferably 240 to 290° C. for 0.1 to 8 hours, preferably 0.25 to 4 hours. Stirring or appropriate conditions are used in both stages to ensure adequate heat transfer and surface renewal of the reaction mixture. The reactions of both stages are facilitated by appropriate catalysts, especially those known in the art, such as alkoxy titanium compounds, alkali metal hydroxides and alcoholates, salts of organic carboxylic acids, alkyl tin compounds, metal oxides, and so forth. A three-stage manufacturing procedure, similar to the teachings of U.S. Pat. No. 5,290,631, incorporated herein by reference, may also be used, particularly when a mixed monomer feed of acids and esters is employed.

Both crystalline and amorphous polyesters are included in this invention. While there is not a preference in regard to static dissipative performance, compositions possessing at least some crystallinity are preferred since they will be more resistant to cold-flow. One of the benefits of crystallinity is that a convenient product form (i.e., pellets) may be possible. This is particularly important in the context of the present invention because the levels of PEG that are required often result in T_{g} values below room temperature. Therefore, amorphous low T_{g} compositions may be difficult to package in a free-flowing product form, which may hamper subsequent processing operations, such as feeding into an extruder. For this reason, crystalline compositions having at least one melting point (Tₘ)>30° C. are preferred.

The polymers described previously are used advantageously as additives for copolyesters to provide a static dissipative article of manufacture. An antistatic film for electronics packaging is one example where a blend would have great utility. Fibers that do not build up static charge are valuable as clothing or carpets. Particularly efficacious is the ability of the polyester-ethers described herein to undergo melt processing with other polyesters without substantial amounts of degradation. On the other hand, the high molecular weights of the polyester-polyethers result in blends where the antistatic additive (i.e., the polyester-polyether) does not bloom to the surface. Polyethylene glycols by themselves are known to suffer from the problem of surface migration. Another desirable aspect of this embodiment of the present invention is the attainment of antistatic polyester/polyester-polyether blends that may possess at least contact clarity. Although it is possible to produce blends by dissolving the polymers in a solvent, this method is much less preferred than the melt blending. Thus, conventional melt blending processes, such as extrusion, are preferred. Coextruded and laminated film structures having two or more layers, wherein at least one layer is comprised of the compositions of the present invention are also within the scope of the present invention.

Electronic components represent a particular technical challenge for antistatic packaging materials. Certain articles of manufacture, such as Hard Disk Drives (HDD), not only require protection from static dissipation, but also require the maintenance of a very clean environment. Therefore, packaging materials of acceptable cleanliness will not exhibit high levels of outgassing or extractables. Extraction of cations and anions is of particular concern and, in the context of this invention, these types of extractables will most prominently occur with antistatic compositions containing sulfonate groups. Sulfomonomers, such as 5-sodiosulfoisophthalates, are typically synthesized by the sulfonation of isophthalic acid or dimethyl isophthalate, followed by neutralization with the appropriate base to obtain the desired counterion. For example, the sulfonic acid intermediate could be neutralized with sodium hydroxide to obtain the sodium salt. Preparative chemistries of this nature usually result in by-product salts due to the reaction of excess sulfonating reagents with excess neutralizing reagents. Standard purification procedures, such as washing, recrystallization, centrifugation, and so forth will reduce these impurities albeit with concomitant yield losses. The surprising efficacy that low levels of sulfomonomers impart to the antistatic polymers (i.e., the additives) of the present invention allows for blending with matrix polymers to form clean packaging materials. Suitable matrix polymers include, but are not limited to polyesters, polyamides, polyurethanes, acrylics, polycarbonates, polyolefins, cellulosics, and blends thereof. Polyesters, polycarbonates, and polyamides are preferred. Polyesters, particularly amorphous copolyesters based on terephthalate, ethylene glycolate, and 1,4-cyclohexane dimethanolate moieties are most preferred. By definition, the matrix polymer will comprise greater than 50% by weight of the blend with the antistatic polymer additive.

Cleanliness testing for extractables is accomplished by immersing a film sample of the polymer in deionized water at a specified temperature for a given amount of time, followed by elemental analysis using a suitable method, such as Inductively Coupled Plasma Mass Spectrometry (ICP-MS). Detailed standard procedures for determining ionic extractables, are available from IDEMA in Document No. M12-99. Although the level of extractable ionics is specified by particular users, in the case of sulfopolyesters, it is particularly desirable that ionic impurities, especially the salt cation, are not extractable in amounts greater than 2 μg/cm² for a film sample, based on an extraction protocol at 70° C. for 60 minutes. In the compositions, blends and articles of the present invention, it is preferred that the individual ionic extractables are less than 0.5 μg/cm² and more preferred that the individual ionic extractables are equal or less than 0.1 μg/cm².

Thus, the antistatic polymer blends according to this aspect of the present invention comprise:

(A) about 50 to 95 wt % based on total weight of the blend of a linear or branched thermoplastic polymer which is other than component B; and

(B) about 5 to 50 wt % based on the total weight of the blend of a block copolymer composition comprising a polyester-polyether prepared from the reaction products of:

(i) a diacid which is other than a sulfomonomer;

(ii) optionally, 0.05 to 5 mole %, based on the total mole % of all carboxyl, ester, and hydroxyl equivalents, of at least one difunctional sulfomonomer containing at least one metal sulfonate group bonded to an aromatic ring wherein the functional groups are ester, carboxyl, or hydroxyl;

(iii) 5 to 50 mole %, based on the total mole % of hydroxyl equivalents, of at least one polyethylene glycol having the structure:

H—(OCH₂CH₂)ₙ—OH

where 22≦n ≦80; and

(iv) from greater than 50 to less than 95 mole %, based on the total moles of hydroxyl equivalents of a glycol or mixture of glycols that is(are) other than a polyethylene glycol;

wherein the polymer is comprised substantially of equal molar proportions of acid equivalents (100 mole %) and glycol equivalents (100 mole %) and wherein the inherent viscosity is at least 0.1 dL/g as measured in a 60/40 parts by weight solution of phenol/tetrachloroethane at 25° C. at a concentration of about 0.25 g of polymer in 100 mL of the solvent.

In the above aspect, the polymer component (A) is preferably generally compatible with polymer component (B). In this regard, it is preferred that the refractive indices for component (A) and component (B) are similar. For some end uses, it is preferred that the polymers are sufficiently compatible to exhibit only one phase upon ordinary visual inspection; however, for some end uses, a level of incompatibility which will impart an opacity upon the blend will be acceptable.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

Synthetic Procedure for Polyester-Polyether Copolymers

A typical procedure is described below. All the polyester-polyether compositions described herein were obtained in the same manner by changing the monomers and/or monomer ratios with appropriate process times, temperatures, and pressures. A 500 mL round bottom flask equipped with a ground glass head, agitator shaft, nitrogen inlet, and a sidearm to allow for removal of volatile materials was charged with 97 grams (0.50 moles) of dimethyl terephthalate, 49.6 grams (0.80 moles) of ethylene glycol, 100.0 grams (0.10) moles of polyethylene glycol, MW=1000 g/mole (PEG1000), and 1.86 mL of a 1.02 wt/vol % solution of titanium(IV)isopropoxide in n-butanol. The flask was purged with nitrogen and immersed in a Belmont metal bath at 200° C. for 70 minutes and 210° C. for 120 minutes under a slow sweep of nitrogen with sufficient agitation. After elevating the temperature to 275° C., the pressure was gradually reduced from 760 mm to 0.20 mm over the course of 25 minutes and held for an additional 37 minutes to perform the polycondensation. The vacuum was displaced with a nitrogen atmosphere and the clear, amber polymer was allowed to cool and crystallize for 90 minutes before removal from the flask. An inherent viscosity of 1.35 dL/g was determined for the recovered polymer according to ASTM D3835-79. NMR analysis indicated that the actual glycol compositional ratio contained 79.4 mole % ethylene glycol and 20.6 mole % PEG1000. A glass transition temperature (T_{g}) of 10° C. and a crystalline melting point (Tₘ) of 177° C. were obtained from thermal analysis by DSC.

### Example 2

Synthetic Procedure for Sulfopolyester-Polyethers

The apparatus described in EXAMPLE 1 was charged with 92.2 g ((0.475 moles) of dimethyl terephthalate, 7.4 grams (0.025 moles) dimethyl-5-sodiosulfoisophthalate (5-SSIPA), 52.7 grams (0.85 moles) ethylene glycol, 108.8 grams (0.075 moles) polyethylene glycol (MW=1450 g/mole), and 0.99 mL of a 1.02 wt/vol % solution of titanium(IV)tetraisopropoxide in n-butanol. After purging with nitrogen, the flask was immersed in the metal bath at 200° C. for 70 minutes and 210° C. for 120 minutes under a nitrogen purge with agitation maintained at 225 RPM. The temperature was increased to 250° C. and the pressure reduced from ambient to 0.2 mm over the course of 25 minutes. A hold time of 150 minutes under vacuum resulted in an opaque, semicrystalline polymer having an IhV of 0.66 dL/g. NMR analysis confirmed that the composition contained 5 mole % of 5-SSIPA with a glycol ratio of 81 mole % EG, 3 mole % DEG, and 16 mole % PEG 1450. A glass transition temperature (T_{g}) of −30° C. and two melting points (Tₘ) at 23 and 199° C. were observed by DSC; it is probable that one of the melting points was due to the long PEG segments and the other resulted from the PET portions that were internally plasticized by the PEG.

### Examples 3,4 and 5 (Comparative)

Effect of Sulfonate Content on Conductivity

These EXAMPLES show that high levels (5-10 mole %) of 5-SSIPA do not provide superior performance over low levels (1 mole %) of 5-SSIPA. In all cases the sulfopolyester-polyethers were made in the manner of EXAMPLE 2 and melt processed via extruder with a commercial copolyester, EASTMAN PETG 6763, which is an amorphous composition based on terephthalate, ethylene glycolate, and 1,4-cylcohexane dimethanolate moieties.

| | | | | Conductivity | |
|---|---|---|---|---|---|
| | % 5- | Wt % Blend | Na | (log | |
| | SSIPA | Composition | Extraction | Resistance) | |
| | (x = | PETG: Sulfopoly | @ 70° C., 1 | 12% | 50% |
| Example | mole %) | ester | hr (μg/cm²) | RH | RH |
| 3 | 1 | 75:25 | | 10.8 | 9.8 |
| | | 70:30 | 0.4 | 10.6 | 9.6 |
| | | 65:35 | | 10.5 | 9.6 |
| 4 | 5 | 80:20 | | 11.1 | 10.0 |
| | | 75:25 | | 10.8 | 9.7 |
| | | 70:30 | 1.9 | 10.3 | 9.1 |
| 5 | 10 | 75:25 | 3.6 | 11.0 | 9.8 |
| | | 70:30 | | 10.5 | 9.3 |
| | | 65:35 | | 10.1 | 8.9 |

The general composition for the polyesters is (100−x) terephthalic acid, (x) 5-SSIPA, 85 mole % EG and 15 mole % PEG1450.

### Examples 6 (Comparative) and 7 (Comparative)

Lower End Molecular Weight Requirement for Polyethylene Glycol

These EXAMPLES show that low molecular weight polyethylene glycols, such as DEG and TEG do not result in static dissipative sulfopolyesters when compared to a sulfopolyester containing a high molecular weight PEG.

| | | Conductivity @ ambient |
|---|---|---|
| EXAMPLE | Composition (mole %) | RH |
| 6 | isophthalic acid, 88; | 13.1 |
| | 5-SSIPA, 12; DEG, 29; | |
| | TEG; 71 | |
| 7 | isophthalic acid, 88; | 10.7 |
| | 5-SSIPA, 12; DEG, 95; | |
| | PEG 1000, 5 | |

### Examples 8, 9 (Comparative), 10, and 11 (Comparative)

Efficacy of PEG Versus Other Polyalkylene Ether Glycols

These EXAMPLES show that polyalkylene ether glycols, other than PEG do not provide the static dissipative performance that is observed for polyethylene glycols.

| EXAMPLE | Composition (mole %) | Conductivity @ 50% RH |
|---|---|---|
| 8 | terephthalic acid, 100; | 10.8 |
| | EG, 90; PEG 1000, 10 | |
| 9 | terephthalic acid, 100; | 13.7 |
| | EG, 90; PTMG 1000, | |
| | 10 | |
| 10 | terephthalic acid, 95; | 9.2 |
| | 5-SSIPA, 5; EG, 90; | |
| | PEG 1000, 10 | |
| 11 | terephthalic acid, 95; | 12.4 |
| | 5-SSIPA, 5; EG, 90; | |
| | PTMG 1000, 10 | |

### Examples 12, 13, 14, and 15 (Comparative)

Higher End Molecular Weight Requirement for Polyethylene Glycol

These EXAMPLES show that there is an optimum molecular weight (around 2000 g/mole) for the PEG segment and higher molecular weights, such as PEG 8000, even at high levels of incorporation, result in decreased performance. EXAMPLES 12, 13, and 14 all contain about 50 weight % of PEG (of varying number average molecular weights) to show the effect of PEG molecular weight at an essentially constant level of incorporation within the polymer.

| | Composition | | Conductivity (log R) | |
|---|---|---|---|---|
| EXAMPLE | (mole %) | Wt % PEG | 12% RH | 50% RH |
| 12 | terephthalic acid, | 53 | 11.0 | 9.8 |
| | 100; EG, 80; PEG | | | |
| | 1000, 20 | | | |
| 13 | terephthalic acid, | 52 | 10.5 | 9.2 |
| | 100; EG, 90, PEG | | | |
| | 2000, 10 | | | |
| 14 | terephthalic acid, | 47 | 11.0 | 10.0 |
| | 100; EG, 95, PEG | | | |
| | 3400, 5 | | | |
| 15 | terephthalic acid, | 81 | 12.1 | 10.7 |
| | 100; EG, 90; PEG | | | |
| | 8000, 10 | | | |

### Examples 16, and 17 (Comparative)

Limit of PEG Level of Incorporation in Polyester-Polyether

These EXAMPLES show that very high levels of PEG do not result in conductivities above those found in the specified range from 5 to 50 mole % and may actually result in poorer performance. In addition, high levels of PEG result in a waxy polymer that is difficult to process. Note that EXAMPLE 16 is the same polymer as EXAMPLE 13.

| | Composition | Mole % PEG | Conductivity (log R) @ |
|---|---|---|---|
| EXAMPLE | (mole %) | (Wt % PEG) | 50% RH |
| 16 | terephthalic acid, | 10 | 9.2 |
| | 100; EG, 90, PEG | (52) | |
| | 2000, 10 | | |
| 17 | terephthalic acid, | 65 | 9.9 |
| | 100; EG, 35, PEG | (90) | |
| | 2000, 65 | | |

### Example 18 (Comparative)

A typical synthetic procedure is described below. A 1000 ml round bottom flask equipped with a ground glass head, agitator shaft, nitrogen inlet, and a sidearm to allow for removal of volatile materials was charged with 145.7 grams (0.75 moles) of dimethyl terephthalate, 81.9 grams (1.32 moles) of ethylene glycol, 162.8 grams (0.18 moles) of poly(ethylene glycol) (Mₙ=900 gram per mole), 1.475 grams of antioxidant, and 1.2 ml of a 1.25 wt/vol % solution of titanium(IV) isopropoxide in n-butanol. The flask was purged with nitrogen and immersed in a Belmont metal bath at 200° C. for 65 minutes and 210° C. for 130 minutes under a slow sweep of nitrogen with sufficient agitation. After elevating the temperature to 275° C., the pressure was gradually reduced from 760 mm to 0.2 mm over the course of 15 minutes and held for an additional 90 minutes to allow for the polycondensation reaction to occur. The vacuum was then displaced with a nitrogen atmosphere and the opaque, amber polymer was allowed to cool and crystallize for at least 60 minutes before removal from the flask. An inherent viscosity of 1.23 dl/g was determined for the recovered polymer according to ASTM D3835-79. Nuclear magnetic resonance (NMR) analysis indicated that the actual composition is comprised of 54.39 wt % PEG900, 37.10 wt % terephthalic acid, 8.13 wt % ethylene glycol and 0.38 wt % diethylene glycol. Glass transition temperature (T_{g}) of −31.37° C. and crystalline melting point (Tₘ) of 180.44° C. were obtained from thermal analysis by differential scanning calorimetry. A compression molded film of the resulting polymer exhibited a surface resistivity of 2.7×10¹⁰ ohms per square at 22° C. and 50% relative humidity according to the ANSI ESD S11.11 standard test method entitled “Surface Resistance Measurements of Static Dissipative Planar Materials.”

### Example 19

A composition of a polyetherester was obtained by a method similar to that as described in EXAMPLE 18 except that 174.8 grams (0.90 moles) of dimethyl terephthalate, 105.6 grams (1.70 moles) of ethylene glycol, 198.0 grams (0.14 moles) of poly(ethylene glycol) (Mₙ=1450 grams per mole), 1.83 grams of antioxidant, and 1.5 ml of a 1.25 wt/vol % solution of titanium(IV) isopropoxide in n-butanol were used in the polymerization feed. An inherent viscosity of 0.76 dl/g was determined for the recovered polymer according to ASTM D3835-79. Nuclear magnetic resonance (NMR) analysis indicated that the actual composition is comprised of 55.17 wt % PEG1450, 35.86 wt % terephthalic acid, and 8.97 wt % ethylene glycol. Glass transition temperature (T_{g}) of −46.05° C. and crystalline melting points (Tₘ) of 20.21° C. and 206.03° C. were obtained from thermal analysis by differential scanning calorimetry. A compression molded film of the resulting polymer exhibited a surface resistivity of 2.1×10⁹ ohms per square at 22° C. and 50% relative humidity according to the ANSI ESD S11.11 standard test method entitled “Surface Resistance Measurements of Static Dissipative Planar Materials.”

### Example 20

A composition of a polyetherester was obtained by a method similar to that as described in EXAMPLE 18 except that 174.8 grams (0.90 moles) of dimethyl terephthalate, 105.5 grams (1.70 moles) of ethylene glycol, 198.15 grams (0.10 moles) of poly(ethylene glycol) (Mₙ=2000 grams per mole), 1.82 grams of antioxidant, and 1.5 ml of a 1.25 wt/vol % solution of titanium(IV) isopropoxide in n-butanol were used in the polymerization feed. An inherent viscosity of 1.22 dl/g was determined for the recovered polymer according to ASTM D3835-79. Nuclear magnetic resonance (NMR) analysis indicated that the actual composition is comprised of 55.16 wt % PEG2000, 35.51 wt % terephthalic acid, and 9.33 wt % ethylene glycol. Glass transition temperature (T_{g}) of −46.90° C. and crystalline melting points (Tₘ) of 27.72° C. and 214.14° C. were obtained from thermal analysis by differential scanning calorimetry. A compression molded film of the resulting polymer exhibited a surface resistivity of 1.5×10⁹ ohms per square at 22° C. and 50% relative humidity according to the ANSI ESD S11.11 standard test method entitled “Surface Resistance Measurements of Static Dissipative Planar Materials.”

### Example 21

A composition of a polyetherester was obtained by a method similar to that as described in EXAMPLE 18 except that 174.8 grams (0.90 moles) of dimethyl terephthalate, 108.0 grams (1.74 moles) of ethylene glycol, 196.0 grams (0.058 moles) of poly(ethylene glycol) (Mₙ=3350 grams per mole), 1.83 grams of antioxidant, and 1.5 ml of a 1.25 wt/vol % solution of titanium(IV) isopropoxide in n-butanol were used in the polymerization feed. An inherent viscosity of 1.07 dl/g was determined for the recovered polymer according to ASTM D3835-79. Nuclear magnetic resonance (NMR) analysis indicated that the actual composition is comprised of 54.89 wt % PEG3350, 35.33 wt % terephthalic acid, and 9.78 wt % ethylene glycol. Crystalline melting points (Tₘ) of 36.97° C. and 227.66° C. were obtained from thermal analysis by differential scanning calorimetry. A compression molded film of the resulting polymer exhibited a surface resistivity of 1.9×10⁹ ohms per square at 22° C. and 50% relative humidity according to the ANSI ESD S11.11 standard test method entitled “Surface Resistance Measurements of Static Dissipative Planar Materials.”

### Example 22 (Comparative)

A composition of a polyetherester was obtained by a method similar to that as described in EXAMPLE 18 except that 145.7 grams (0.75 moles) of dimethyl terephthalate, 90.84 grams (1.46 moles) of ethylene glycol, 162.5 grams (0.035 moles) of poly(ethylene glycol) (Mₙ=4600 grams per mole), 1.52 grams of antioxidant, and 1.2 ml of a 1.25 wt/vol % solution of titanium(IV) isopropoxide in n-butanol were used in the polymerization feed. An inherent viscosity of 1.27 dl/g was determined for the recovered polymer according to ASTM D3835-79. Nuclear magnetic resonance (NMR) analysis indicated that the actual composition is comprised of 54.65 wt % PEG4600, 35.30 wt % terephthalic acid, 9.90 wt % ethylene glycol and 0.15 wt % diethylene glycol. Crystalline melting points (Tₘ) of 41.71° C. and 235.05° C. were obtained from thermal analysis by differential scanning calorimetry. A compression molded film of the resulting polymer exhibited a surface resistivity of 5.3×10⁹ ohms per square at 22° C. and 50% relative humidity according to the ANSI ESD S11.11 standard test method entitled “Surface Resistance Measurements of Static Dissipative Planar Materials.”

### Example 23 (Comparative)

A composition of a polyetherester was obtained by a method similar to that as described in EXAMPLE 18 except that 145.7 grams (0.75 moles) of dimethyl terephthalate, 92.2 grams (1.49 moles) of ethylene glycol, 162.6 grams (0.020 moles) of poly(ethylene glycol) (Mₙ=8000 grams per mole), 1.53 grams of antioxidant, and 1.2 ml of a 1.25 wt/vol % solution of titanium(IV) isopropoxide in n-butanol were used in the polymerization feed. An inherent viscosity of 1.53 dl/g was determined for the recovered polymer according to ASTM D3835-79. Nuclear magnetic resonance (NMR) analysis indicated that the actual composition is comprised of 53.84 wt % PEG8000, 35.65 wt % terephthalic acid, 10.10 wt % ethylene glycol and 0.40 wt % diethylene glycol. Crystalline melting points (Tₘ) of 52.08° C. and 242.22° C. were obtained from thermal analysis by differential scanning calorimetry. A compression molded film of the resulting polymer exhibited a surface resistivity of 3.8×10¹⁰ ohms per square at 22° C. and 50% relative humidity according to the ANSI ESD S11.11 standard test method entitled “Surface Resistance Measurements of Static Dissipative Planar Materials.”

### Example 24 (Comparative)

A composition of a polyetherester was obtained by a method similar to that as described in EXAMPLE 18 except that 116.5 grams (0.60 moles) of dimethyl terephthalate, 60.1 grams (0.97 moles) of ethylene glycol, 208.4 grams (0.23 moles) of poly(ethylene glycol) (Mₙ=900 grams per mole), 1.55 grams of antioxidant, and 1.2 ml of a 1.25 wt/vol % solution of titanium(IV) isopropoxide in n-butanol were used in the polymerization feed. An inherent viscosity of 1.19 dl/g was determined for the recovered polymer according to ASTM D3835-79. Nuclear magnetic resonance (NMR) analysis indicated that the actual composition is comprised of 66.31 wt % PEG900, 28.46 wt % terephthalic acid, 5.07 wt % ethylene glycol and 0.17 wt % diethylene glycol. Glass transition temperature (T_{g}) of −48.94° C. and crystalline melting points (Tₘ) of 7.27° C. and 113.34° C. were obtained from thermal analysis by differential scanning calorimetry. A compression molded film of the resulting polymer exhibited a surface resistivity of 8.5×10⁹ ohms per square at 22° C. and 50% relative humidity according to the ANSI ESD S11.11 standard test method entitled “Surface Resistance Measurements of Static Dissipative Planar Materials.”

### Example 25

A composition of a polyetherester was obtained by a method similar to that as described in EXAMPLE 18 except that 136.0 grams (0.70 moles) of dimethyl terephthalate, 76.5 grams (1.23 moles) of ethylene glycol, 198.0 grams (0.17 moles) of poly(ethylene glycol) (Mₙ=1450 grams per mole), 1.84 grams of antioxidant, and 1.5 ml of a 1.25 wt/vol % solution of titanium(IV) isopropoxide in n-butanol were used in the polymerization feed. An inherent viscosity of 0.67 dl/g was determined for the recovered polymer according to ASTM D3835-79. Nuclear magnetic resonance (NMR) analysis indicated that the actual composition is comprised of 66.98 wt % PEG 1450, 27.04 wt % terephthalic acid, and 5.98 wt % ethylene glycol. Glass transition temperature (T_{g}) of −42.82° C. and crystalline melting points (Tₘ) of 28.57° C. was obtained from thermal analysis by differential scanning calorimetry. A compression molded film of the resulting polymer exhibited a surface resistivity of 9.4×10⁸ ohms per square at 22° C. and 50% relative humidity according to the ANSI ESD S11.11 standard test method entitled “Surface Resistance Measurements of Static Dissipative Planar Materials.”

### Example 26

A composition of a polyetherester was obtained by a method similar to that as described in EXAMPLE 18 except that 136.0 grams (0.70 moles) of dimethyl terephthalate, 79.3 grams (1.28 moles) of ethylene glycol, 246.5 grams (0.12 moles) of poly(ethylene glycol) (Mₙ=2000 grams per mole), 1.87 grams of antioxidant, and 1.5 ml of a 1.25 wt/vol % solution of titanium(IV) isopropoxide in n-butanol were used in the polymerization feed. An inherent viscosity of 1.28 dl/g was determined for the recovered polymer according to ASTM D3835-79. Nuclear magnetic resonance (NMR) analysis indicated that the actual composition is comprised of 66.98 wt % PEG2000, 26.60 wt % terephthalic acid, and 6.42 wt % ethylene glycol. Crystalline melting points (Tₘ) of 34.38° C. and 183.30° C. were obtained from thermal analysis by differential scanning calorimetry. A compression molded film of the resulting polymer exhibited a surface resistivity of 8.3×10⁸ ohms per square at 22° C. and 50% relative humidity according to the ANSI ESD S11.11 standard test method entitled “Surface Resistance Measurements of Static Dissipative Planar Materials.”

### EXAMPLE 27

A composition of a polyetherester was obtained by a method similar to that as described in EXAMPLE 18 except that 106.9 grams (0.55 moles) of dimethyl terephthalate, 64.7 grams (1.04 moles) of ethylene glycol, 195.3 grams (0.058 moles) of poly(ethylene glycol) (Mₙ=3350 grams per mole), 1.49 grams of antioxidant, and 1.2 ml of a 1.25 wt/vol % solution of titanium(IV) isopropoxide in n-butanol were used in the polymerization feed. An inherent viscosity of 1.25 dl/g was determined for the recovered polymer according to ASTM D3835-79. Nuclear magnetic resonance (NMR) analysis indicated that the actual composition is comprised of 67.17 wt % PEG3350, 25.94 wt % terephthalic acid, 6.76 wt % ethylene glycol and 0.12 wt % diethylene glycol. Crystalline melting points (Tₘ) of 41.94° C. and 212.46° C. were obtained from thermal analysis by differential scanning calorimetry. A compression molded film of the resulting polymer exhibited a surface resistivity of 7.5×10⁹ ohms per square at 22° C. and 50% relative humidity according to the ANSI ESD S11.11 standard test method entitled “Surface Resistance Measurements of Static Dissipative Planar Materials.”

### Example 28 (Comparative)

A composition of a polyetherester was obtained by a method similar to that as described in EXAMPLE 18 except that 106.9 grams (0.55 moles) of dimethyl terephthalate, 65.7 grams (1.06 moles) of ethylene glycol, 195.1 grams (0.042 moles) of poly(ethylene glycol) (Mₙ=4600 grams per mole), 1.49 grams of antioxidant, and 1.2 ml of a 1.25 wt/vol % solution of titanium(IV) isopropoxide in n-butanol were used in the polymerization feed. An inherent viscosity of 1.38 dl/g was determined for the recovered polymer according to ASTM D3835-79. Nuclear magnetic resonance (NMR) analysis indicated that the actual composition is comprised of 67.14 wt % PEG4600, 25.82 wt % terephthalic acid, 7.02 wt % ethylene glycol and 0.02 wt % diethylene glycol. Crystalline melting points (Tₘ) of 45.79° C. and 224.47° C. were obtained from thermal analysis by differential scanning calorimetry. A compression molded film of the resulting polymer exhibited a surface resistivity of 1.3×10¹⁰ ohms per square at 22° C. and 50% relative humidity according to the ANSI ESD S11.11 standard test method entitled “Surface Resistance Measurements of Static Dissipative Planar Materials.”

### Example 29 (Comparative)

A composition of a polyetherester was obtained by a method similar to that as described in EXAMPLE 18 except that 106.8 grams (0.55 moles) of dimethyl terephthalate, 66.7 grams (1.08 moles) of ethylene glycol, 195.8 grams (0.024 moles) of poly(ethylene glycol) (Mₙ=8000 grams per mole), 1.50 grams of antioxidant, and 1.2 ml of a 1.25 wt/vol % solution of titanium(IV) isopropoxide in n-butanol were used in the polymerization feed. An inherent viscosity of 1.42 dl/g was determined for the recovered polymer according to ASTM D3835-79. Nuclear magnetic resonance (NMR) analysis indicated that the actual composition is comprised of 67.26 wt % PEG8000, 25.45 wt % terephthalic acid, 7.10 wt % ethylene glycol and 0.20 wt % diethylene glycol. Crystalline melting points (Tₘ) of 52.34° C. and 237.39° C. were obtained from thermal analysis by differential scanning calorimetry. A compression molded film of the resulting polymer exhibited a surface resistivity of 1.8×10¹⁰ ohms per square at 22° C. and 50% relative humidity according to the ANSI ESD S11.11 standard test method entitled “Surface Resistance Measurements of Static Dissipative Planar Materials.”

The Effect of Polyethylene Glycol Molecular Weight on the Rₛ of Inherently Electrostatic Dissipating Block Copolymers Containing 55 Wt. % Polyethylene Glycol

Table 1 summarizes the electrostatic dissipating properties of the inherently electrostatic dissipating polyetherester block copolymers described by EXAMPLES 18-23 containing approximately 55 wt % polyethylene glycol of varying molecular weights. These examples show that the inherently electrostatic dissipating block copolymer compositions containing polyethylene glycol of a molecular weight within the range of 1450 to 3350 grams per mole exhibit improved electrostatic dissipating properties as demonstrated by lower Rₛ than compositions containing polyethylene glycol outside of this molecular weight range.

TABLE 1

| | PEG MW | Wt % | (Rₛ) |
|---|---|---|---|
| Example | (grams per mole) | PEG | (ohm per sq) |
| 18 | 900 | 54 | 2.7 × 10¹⁰ |
| 19 | 1450 | 55 | 2.1 × 10⁹ |
| 20 | 2000 | 55 | 1.5 × 10⁹ |
| 21 | 3350 | 55 | 1.9 × 10⁹ |
| 22 | 4600 | 55 | 5.3 × 10⁹ |
| 23 | 8000 | 54 | 3.8 × 10¹⁰ |

The Effect of Polyethylene Glycol Molecular Weight on the Rₛ of Inherently Electrostatic Dissipating Block Copolymers Containing 67 Wt. % of Polyethylene Glycol

Table 2 summarizes the electrostatic dissipating properties of the inherently electrostatic dissipating polyetherester block copolymers described by EXAMPLES 24-29 containing approximately 67 wt % polyethylene glycol of varying molecular weights. These examples show that the inherently electrostatic dissipating block copolymer compositions containing polyethylene glycol of a molecular weight within the range of 1450 to 3350 grams per mole exhibit improved electrostatic dissipating properties as demonstrated by lower Rₛ than compositions containing polyethylene glycol outside of this molecular weight range.

TABLE 2

| | PEG MW | | (Rₛ) |
|---|---|---|---|
| | (grams per | Wt % | (ohm per |
| Example | mole) | PEG | sq) |
| 24 | 900 | 66 | 8.5 × 10⁹ |
| 25 | 1450 | 67 | 9.4 × 10⁸ |
| 26 | 2000 | 67 | 8.3 × 10⁸ |
| 27 | 3350 | 67 | 7.5 × 10⁹ |
| 28 | 4600 | 67 | 1.3 × 10¹⁰ |
| 29 | 8000 | 67 | 1.8 × 10¹⁰ |

For EXAMPLES 30 through 35, the following is to be noted.

Eastar® PETG 6763 is copolyester based on terephthalic acid, ethylene glycol, and 1,4-cyclohexanedimethanol produced and sold by the Eastman Chemical Company.

### Examples 30-35

Polymer Alloys with Inherently Electrostatic Dissipating Block Copolymers Containing 55 Wt. % Polyethylene Glycol

Polymer alloys comprised of 59.6 weight percent Eastar® PETG 6763, 30 weight percent of inherently electrostatic dissipating block copolymer (IDP) described above in EXAMPLES 18-23, 9.9 weight percent compatibilizer, and 0.5 weight percent antioxidant were prepared on an APV 19-mm twin screw extruder using a feed rate of 5 pounds per hour, a screw speed of 200 RPM, and a melt temperature of 240° C. Cast film samples were subsequently prepared on a 1-inch Killion single screw extruder equipped with a Maddock mixing screw using a screw speed of 115 RPM and a melt temperature of 255° C. The Rₛ of the blends measured according to ANSI ESD S11.11 at 50% relative humidity are shown in Table 3. These examples show that the polymer alloys comprised of inherently electrostatic dissipating block copolymers containing polyethylene glycol of a molecular weight within the range of 1450 to 3350 grams per mole exhibit improved electrostatic dissipating properties as demonstrated by lower Rₛ than alloys comprised of inherently electrostatic dissipating block copolymers containing polyethylene glycol outside of this molecular weight range.

TABLE 3

| | IDP | Rₛ |
|---|---|---|
| Example | Example | (ohms per sq) |
| 30 | 18 | 5.99 × 10¹¹ |
| 31 | 19 | 9.07 × 10¹⁰ |
| 32 | 20 | 3.42 × 10¹⁰ |
| 33 | 21 | 5.61 × 10¹⁰ |
| 34 | 22 | 5.32 × 10¹⁰ |
| 35 | 23 | 2.39 × 10¹² |

### Examples 36-41

Polymer Alloys with Inherently Electrostatic Dissipating Block Copolymers Containing 67 Wt. % Polyethylene Glycol

Polymer alloys comprised of 59.6 weight percent Eastar® PETG 6763, 30 weight percent of inherently electrostatic dissipating block copolymer (IDP) described above in EXAMPLES 18-23, 9.9 weight percent compatibilizer, and 0.5 weight percent antioxidant were prepared on an APV 19-mm twin screw extruder using a feed rate of 5 pounds per hour, a screw speed of 200 RPM, and a melt temperature of 240° C. Cast film samples were subsequently prepared on a 1-inch Killion single screw extruder equipped with a Maddock mixing screw using a screw speed of 115 RPM and a melt temperature of 255° C. The Rₛ of the blends measured according to ANSI ESD S11.11 at 50% relative humidity are shown in Table 4. These examples show that the polymer alloys comprised of inherently electrostatic dissipating block copolymers containing polyethylene glycol of a molecular weight within the range of 1450 to 3350 grams per mole exhibit improved electrostatic dissipating properties as demonstrated by lower Rₛ than alloys comprised of inherently electrostatic dissipating block copolymers containing polyethylene glycol outside of this molecular weight range.

TABLE 4

| | | Rₛ |
|---|---|---|
| Example | IDP Example | (ohms per sq) |
| 36 | 24 | 9.82 × 10¹⁰ |
| 37 | 25 | 5.56 × 10¹⁰ |
| 38 | 26 | 9.91 × 10⁹ |
| 39 | 27 | 5.92 × 10¹⁰ |
| 40 | 28 | 9.42 × 10¹⁰ |
| 41 | 29 | 7.11 × 10¹² |

### LIST OF ABBREVIATIONS

DEG: diethylene glycol

EG: ethylene glycol

HDD: Hard disk drive

ICP-MS Inductively Coupled Plasma Mass Spectrometry

PEG: polyethylene glycol

PET: polyethylene terephthalate

PTMG: polytetramethylene glycol

5-SIPA: 5-sulfoisophthalic acid

5-SSIPA: 5-sodiosulfoisophthalic acid

TEG: triethylene glycol

The invention has been described in detail with particular reference to preferred embodiments thereof, but it will be understood that variations and modifications can be effected within the spirit and scope of the invention. We claim:

1. A block copolymer composition comprising a polyester-polyether prepared from the reaction products of:
(i) a diacid which is other than a sulfomonomer;
(ii) optionally, 0.05 to 5 mole %, based on the total mole % of all carboxyl, ester, and hydroxyl equivalents, of at least one difunctional sulfomonomer containing at least one metal sulfonate group bonded to an aromatic ring wherein the functional groups are ester, carboxyl, or hydroxyl;
(iii) 5 to 50 mole %, based on the total mole % of hydroxyl equivalents, of at least one polyethylene glycol having the structure:
H—(OCH₂CH₂)ₙ—OH
where 22≦n≦80; and
(iv) from greater than 50 to less than 95 mole %, based on the total moles of hydroxyl equivalents of a glycol or mixture of glycols that is(are) other than a polyethylene glycol;
wherein the polymer is comprised substantially of equal molar proportions of acid equivalents (100 mole %) and glycol equivalents (100 mole %) and wherein the inherent viscosity is at least 0.1 dL/g as measured in a 60/40 parts by weight solution of phenol/tetrachloroethane at 25° C. at a concentration of about 0.25 g of polymer in 100 mL of the solvent.

2. The composition of claim 1, wherein n is 30 to 60.

3. The composition of claim 1, wherein component (ii) is present.

4. The composition of claim 1, wherein component (iii) is present in a range of 5 to 40 mole percent.

5. The composition of claim 1, wherein component (iii) is present in a range of 0 10 to 30 mole percent.

6. The composition of claim 1, wherein the diacid is selected from the group consisting of succinic; glutaric; adipic; azelaic; sebacic; fumaric; maleic; itaconic; 1,3-cyclohexane dicarboxlic; 1,4-cyclohexanedicarboxylic; diglycolic; 2,5-norbornanedicarboxylic; phthalic; terephthalic; 1,4-naphthalenedicarboxylic; 2,5-naphthalenedicarboxylic; 2,6-naphthalenedicarboxylic; 2,7- naphthalenedicarboxylic; diphenic; 4,4′-oxydibenzoic; 4,4′-sulfonyldibenzoic; and isophthalic acids.

7. The composition of claim 1, wherein the ionic extractables are ≦2 μg/cm² for an 8 cm² film prepared from said composition, placed in about 50 mL of deionized water at 70° C. for 60 minutes

8. A polymer blend comprising:
(A) about 50 to 95wt % based on total weight of the blend of a linear or branched thermoplastic polymer which is other than component; and
(B) about 5 to 50 wt % based on the total weight of the blend of a block copolymer composition comprising a polyester-polyether prepared from the reaction products of:
(iii) a diacid which is other than a sulfomonomer;
(iv) optionally, 0.05 to 5 mole %, based on the total mole % of all carboxyl, ester, or and hydroxyl equivalents, of at least one difunctional sulfomonomer containing at least one metal sulfonate group bonded to an aromatic ring wherein the functional groups are ester, carboxyl, or hydroxyl;
(iii) 5 to 50 mole %, based on the total mole % of hydroxyl equivalents, of at least one polyethylene glycol having the structure:
H—(OCH₂CH₂)ₙ—OH
where 22≦n≦80; and
(iv) from greater than 50 to less than 95 mole %, based on the total moles of hydroxyl equivalents of a glycol or mixture of glycols that is(are) other than a polyethylene glycol;
wherein the polymer is comprised substantially of equal molar proportions of acid equivalents (100 mole %) and glycol equivalents (100 mole %) and wherein the inherent viscosity is at least 0.1 dL/g as measured in a 60/40 parts by weight solution of phenol/tetrachloroethane at 25° C. at a concentration of about 0.25 g of polymer in 100 mL of the solvent.

9. The blend of claim 8, wherein the ionic extractables are ≦2 μg/cm² for an 8 cm² film, prepared from said blend, placed in about 50 mL of deionized water at 70° C. for 60 minutes

10. The blend of claim 8, wherein component (A) is selected from the group consisting of polyesters, polyamides, polyurethanes, acrylics, polycarbonates, cellulosics, and blends thereof.

11. The blend of claim 8, wherein n is 30 to 60.

12. A shaped, molded, or formed article comprising the composition of claim 1.

13. A film or sheet comprising the composition of claim 1.

14. A shaped or formed article comprising the composition of claim 8.

15. A film or sheet comprising the composition of claim 8.

16. The sheet of claim 15 which has been extruded.

17. A laminate having at least two layers wherein at least one layer of said laminate is comprised of the composition of claim 1.
